(19) United States
(12) Patent Application Publication
(10) Pub. No.: US 2021/0359586 A1
(43) Pub. Date: Nov. 18, 2021

(54) MAGNETIC LINE OF FORCE INERTIAL WHEEL AND MANUFACTURING METHOD THEREOF

(71) Applicant: Amoy YG Sports Technology Co., Ltd., Xiamen (CN)

(72) Inventor: Yu SUN, Xiamen (CN)

(21) Appl. No.: 17/234,403

(22) Filed: Apr. 19, 2021

(30) Foreign Application Priority Data
May 12, 2020 (CN) 202010396833.X

(51) Int. Cl. H02K 49/10; H02K 15/14

(52) U.S. Cl. CPC H02K 49/102; H02K 15/14

(57) ABSTRACT

A magnetic line of force inertial wheel and a manufacturing method thereof is disclosed, including a counterweight part made of a mixture of a weak magnetic cementing material and a strong magnetic high-density material, an isolate part made of at least one of a weak magnetic cementing material and a weak magnetic material, and a cut part made of a weak magnetic conductor; the isolate part is circumferentially fixed on a peripheral side wall of the counterweight part, and the cut part is circumferentially fixed on a peripheral side wall of the isolate part. Through the structural design of the isolate part, the inertial wheel prevents the brake pads may be prevented from being adsorbed on the wheel when the inertial wheel is braking, a better user experience can be present.

### TECHNICAL FIELD

The present disclosure relates to the field of inertial wheels, and in particular, to a magnetic line of force inertial wheel and a manufacturing method thereof.

### BACKGROUND

Magnetic line of force inertial wheel structure currently adopts three forms on the market: 1, the wheel body is formed by casting, and the outer periphery is covered with an aluminum ring; 2, the housing is formed by stamping process or spinning process, and the housing is filled with iron powder and other counterweights, with an aluminum ring wrapped outside; 3, the housing is injection-molded, and the housing is filled with cement and iron sand to be processed into concrete as a counterweight, with an aluminum ring wrapped outside.

The inertia wheels of the above three structures all have the phenomenon of being attracted by magnets. When adjusting the resistance of a magnetically controlled racing car, it is obviously necessary to increase the pressing force value or the adjusting force value, such that the user's experience comfort is greatly reduced. Moreover, the production cost of the inertia wheels of the above three structures is relatively high.

### SUMMARY

To this end, it is necessary to provide magnetic line of force inertia wheel and a manufacturing method thereof having a low-cost and a good-user's experience.

In order to solve the above technical problems, a technical solution adopted by the present disclosure is: a magnetic line of force inertia wheel, including a counterweight part made of a mixture of a weak magnetic cementing material and a strong magnetic high-density material, an isolate part made of at least one of a weak magnetic cementing material and a weak magnetic material, and a cut part made of a weak magnetic conductor; the isolate part being circumferentially fixed on a peripheral side wall of the counterweight part, and the cut part being circumferentially fixed on a peripheral side wall of the isolate part.

Further, the counterweight part is made of weak magnetic cements and strong magnetic ferrous metals.

Further, when the isolate part is made of the weak magnetic conductor, the isolate part and the cut part may be integrated as a whole structure.

Further, the isolate part has a radial width greater than or equal to 20 mm.

Further, a bottom cover and a face cover are further included, and the counterweight part, the isolate part and the cut part are fixed between the bottom cover and the face cover, an outer peripheral side wall of the cut part constitutes an outer peripheral side wall between the bottom cover and the face cover.

Further, the bottom cover is provided with reinforcing ribs embedded in the counterweight part and the isolate part.

Further, the reinforcing ribs are fixedly connected with a plurality of sleeves for allowing screws to enter, and the face cover is fixedly connected with a plurality of threaded cylinders one-to-one corresponding to the sleeves.

Further, the bottom cover and the face cover are tightly connected to the threaded cylinders and the sleeves through the screws.

Further, the bottom cover is connected to the cut part by injection molding.

Further, the cut part is provided with a protrusion embedded in the isolate part in an inner side wall.

Further, the bottom cover and the face cover are made of plastic materials.

In order to make the above technical problem settled, another technical solution adopted by the present disclosure is: a method for manufacturing a magnetic line of force inertia wheel, the method being performed according to the following steps:

S1: preparing a bottom cover and a face cover by injection molding, when molding the bottom cover, a cut part made of a weak magnetic conductor being placed in a mold of molding the bottom cover in advance, such that the cut part is fixedly connected to the bottom cover;

S2: fixing a baffle ring with an outer diameter smaller than an inner diameter of the cut part on the bottom cover, and laying an isolate part made of at least one of a weak magnetic cementing material and a weak magnetic material between the baffle ring and the cut part;

S3: removing the baffle ring, and laying a counterweight part made of a mixture of the weak magnetic cementing material and the strong magnetic high-density material inside the isolate part;

S4: covering the face cover such that the counterweight part, the isolate part and the cut part are fixed between the bottom cover and the face cover, and fixing the face cover and the bottom cover with fasteners.

Compared with the prior art, the present disclosure has the following beneficial effects:

1. The counterweight part made by mixing weak magnetic cementing materials and strong magnetic high-density materials not only takes advantage of the low-cost characteristics of cementing materials, but also has the counterweight function of strong magnetic high-density materials, and the function of ampere resistance increased when cutting magnetic induction line.

2. The isolate part is made of at least one of weak magnetic cementing materials and weak magnetic materials, so that the counterweight part does not directly contact the magnetic brake pad, the magnetic brake pad and the counterweight part are prevented from generating attraction force, that is, the knob of magnetic brake pad does not have to increase the force value in order to overcome the attraction of the magnet, and the purpose of reducing the pressing force value or adjusting force value of the knob can be achieved, and the user experience comfort can be increased.

### BRIEF DESCRIPTION OF DRAWINGS

In order to make the above and other objects, features and advantages of the present disclosure more comprehensible, preferred embodiments are listed in detail below combining with the accompanying drawings.

FIG. 1 is a schematic perspective view showing a structure according to one embodiment of the present disclosure.

FIG. 2 is a schematic exploded view showing a structure according to one embodiment of the present disclosure.

FIG. 3 is a partial cross-sectional view according to one embodiment of the present disclosure.

In the figures: 1—counterweight part, 2—isolate part, 3—cut part, 31—protrusion, 4—face cover, 41—threaded cylinder, 5—bottom cover, 51—reinforcing rib, 52—sleeve, 53—shaft sleeve, 6—rotate shaft.

### DETAILED DESCRIPTION OF THE EXEMPLARY EMBODIMENTS

In order to further illustrate the technical means and effects of the present disclosure to achieve the intended purpose of the disclosure, the specific embodiments, structure, features and effects of the present disclosure will be described in detail below with reference to the accompanying drawings and preferred embodiments.

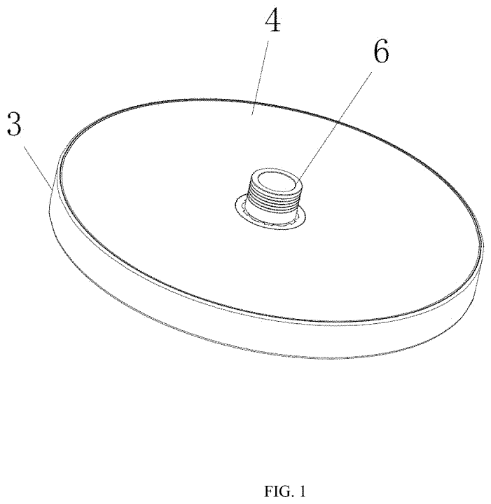

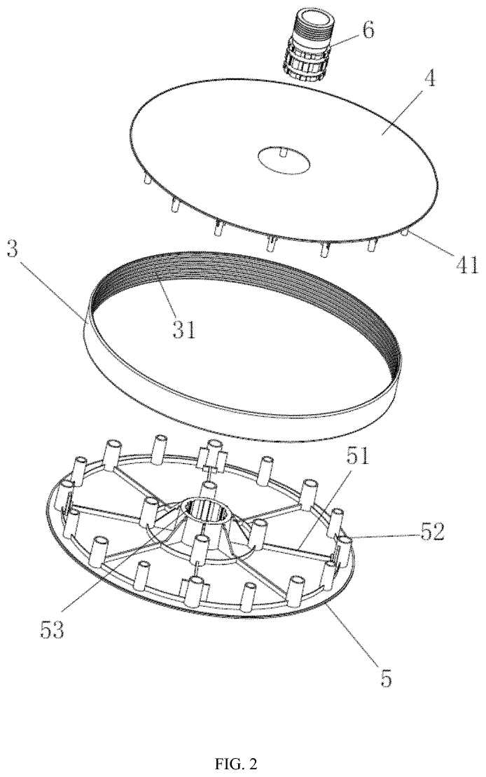

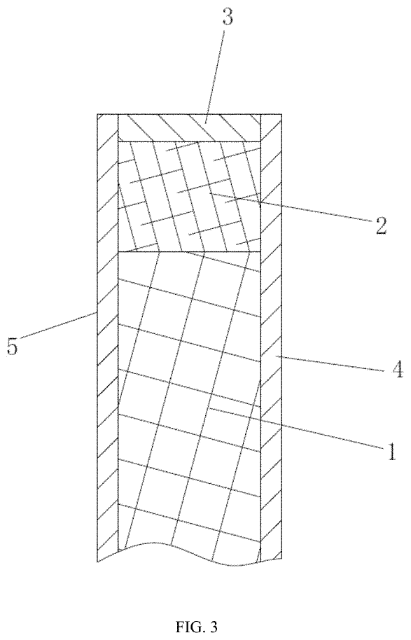

As shown in FIGS. 1-3, a magnetic line of force inertial wheel may include a face cover 4, a bottom cover 5, a counterweight part 1, an isolate part 2 and a cut part 3.

Both the face cover 4 and the bottom cover 5 may be formed by injection molding. In order to better fix and engage the bottom cover 5 and the cut part 3, in the process of injection molding, the cut part 3 may be placed in the mold of molding the bottom cover 5 in advance, and then injection molding the bottom cover 5, such that the cut part 3 is fixedly connected to the bottom cover 5.

The counterweight part 1 may be made of a mixture of weak magnetic cementing material and strong magnetic high-density material. Among them, the weak magnetic cementing material may be preferably cement, and the strong magnetic high-density material may be preferably iron sand. The concrete obtained by mixing cement and iron sand may be made into the counterweight part, it takes advantage of the low cost of cement itself, and also uses the high density of iron sand itself and the characteristic of ampere resistance produced by cutting the magnetic induction wire, the production cost can be reduced when taking into account the counterweight and resistance.

The counterweight part 1 may have an annular shape, and a shaft sleeve 53 and a rotate shaft 6 may be connected to the middle portion thereof. When the inertial wheel is applied to fitness equipment such as spinning bikes, the rotate shaft in the middle portion can be connected to the pedals for transmission.

The isolate part 2 may be made of at least one of a weak magnetic gel material and a weak magnetic material. As an optimal selection, concrete mixed with cement and weak magnetic aggregates (such as sand and gravel) may be adopted to prepare the isolate part 2. Because of the weak magnetism of its material, the isolate part 2 does not generate magnetic attraction between the magnetic brake pads, so the magnetic brake pads do not directly contact the counterweight part. When the knob used to adjust the magnetic brake pads is used to control the magnetic brake pads away from the inertia wheel, it is not necessary to increase the force value of the knob in order to overcome the magnetic attraction, such that the purpose of reducing the pressing force value or the adjusting force value of the knob can be achieved, thereby increasing the comfort of the user experience.

The isolate part 2 may have an annular shape and surround the peripheral side wall of the counterweight part 1.

The cut part 3 may be made of a weak magnetic conductor, preferably made of aluminum or aluminum alloy as a ring body, and may surround the peripheral side wall of the isolate part, and at the same time serve as a peripheral side wall surrounding the bottom cover and the face cover. When the inertial wheel may be applied to exercise equipment such as spinning bikes, the magnetic brake pads and the cut part and counterweight on the inertial wheel will cut magnetic lines of force during riding, thereby generating resistance, and the resistance increases with the decrease of the distance between the magnetic brake pad and the linear inertia wheel, and otherwise, the resistance decreases with the increase of the distance.

If the isolate part 2 is made of the same material as the cut part 3, both, of course, can be integrated as a whole structure, and the effect of cutting the magnetic induction line and the effect of being far away from the contact between the brake pad and the counterweight will be better, but from the aspect of cost, it will lead to an increase in production costs.

In the embodiment, the radial width of the isolate part 2 may be greater than or equal to 20 mm.

In the embodiment, the bottom cover 5 may be provided with reinforcing ribs 51 embedded in the counterweight part 1 and the isolate part 2. A plurality of sleeves 52 for allowing screws to enter may be fixedly connected to the reinforcing ribs 51, and a plurality of threaded cylinders 41 one-to one corresponding to the sleeves 52 may be fixedly connected to the face cover 4, so that when the face cover 4 is buckled on the bottom cover 5, the threaded cylinders 41 may be inserted into the sleeves 52, and the threaded cylinders 41 and the sleeves 52 may be fastened with screws to realize the tight connection between the bottom cover 5 and the face cover 4.

In the embodiment, the inner side wall of the cut part 3 may be provided with a protrusion 31 embedded in the isolate part to enhance its connection with the isolate part 2.

In the embodiment, the face cover 4, the bottom cover 5, the counterweight portion 1, the isolate part 2 and the cut part 3 may be all circular rings with different sizes.

The manufacturing method of the above-mentioned magnetic line of force inertial wheel may be carried out according to the following steps:

S1: preparing a bottom cover 5 and a face cover 4 by injection molding, when molding the bottom cover 5, a cut part 3 made of aluminum being placed in a mold of molding the bottom cover 5 in advance, such that the cut part 3 is fixedly connected to the bottom cover 5;

S2: fixing a baffle ring with an outer diameter smaller than an inner diameter of the cut part 3 on the bottom cover 5, and laying an annular isolate part 2 formed by a concrete made by mixing the cement with the aggregates;

S3: removing the baffle ring, and laying an annular counterweight part 1 formed by a concrete made by mixing the cement and the iron sand inside the isolate part 2;

S4: covering the face cover 4, such that the counterweight part 1, the isolate part 2 and the cut part 3 are fixed between the bottom cover and the face cover, and fixing the face cover 4 and the bottom cover 5 with fasteners.

The above are only the preferred embodiments of the present disclosure, and do not limit the present disclosure in any form. Although the present disclosure has been disclosed as above in preferred embodiments, it is not intended to limit the present disclosure. Those skilled in the art can use the technical solution disclosed above to obtain equivalent embodiments with some changes or modifications considered as equivalent changes without departing from the scope of the technical solution of the present disclosure. However, without departing from the content of the technical solution of the present disclosure, any brief modifications, equivalent changes and improvements made to the above embodiments based on the technical essence of the present disclosure will fall within the scope of the present disclosure.

What is claimed is:

1. A magnetic line of force inertial wheel, wherein comprising:
a counterweight part made of a mixture of a weak magnetic cementing material and a strong magnetic high-density material, an isolate part made of at least one of a weak magnetic cementing material and a weak magnetic material, and a cut part made of a weak magnetic conductor; the isolate part being circumferentially fixed on a peripheral side wall of the counterweight part, and the cut part being circumferentially fixed on a peripheral side wall of the isolate part.

2. The magnetic line of force inertial wheel according to claim 1, wherein the counterweight part is made of weak magnetic cements and strong magnetic ferrous metals.

3. The magnetic line of force inertial wheel according to claim 1, wherein when the isolate part is made of the weak magnetic conductor, the isolate part and the cut part may be integrated as a whole structure.

4. The magnetic line of force inertial wheel according to claim 1, wherein the isolate part has a radial width greater than or equal to 20 mm.

5. The magnetic line of force inertial wheel according to claim 1, wherein further comprising a bottom cover and a face cover, and the counterweight part, the isolate part and the cut part being fixed between the bottom cover and the face cover, an outer peripheral side wall of the cut part constituting an outer peripheral side wall between the bottom cover and the face cover.

6. The magnetic line of force inertial wheel according to claim 2, wherein further comprising a bottom cover and a face cover, and the counterweight part, the isolate part and the cut part being fixed between the bottom cover and the face cover, an outer peripheral side wall of the cut part constituting an outer peripheral side wall between the bottom cover and the face cover.

7. The magnetic line of force inertial wheel according to claim 3, wherein further comprising a bottom cover and a face cover, and the counterweight part, the isolate part and the cut part being fixed between the bottom cover and the face cover, an outer peripheral side wall of the cut part constituting an outer peripheral side wall between the bottom cover and the face cover.

8. The magnetic line of force inertial wheel according to claim 4, wherein further comprising a bottom cover and a face cover, and the counterweight part, the isolate part and the cut part being fixed between the bottom cover and the face cover, an outer peripheral side wall of the cut part constituting an outer peripheral side wall between the bottom cover and the face cover.

9. The magnetic line of force inertial wheel according to claim 5, wherein: the bottom cover is provided with reinforcing ribs embedded in the counterweight part and the isolate part.

10. The magnetic line of force inertial wheel according to claim 6, wherein: the reinforcing ribs are fixedly connected with a plurality of sleeves for allowing screws to enter, and the face cover is fixedly connected with a plurality of threaded cylinders one-to-one corresponding to the sleeves.

11. The magnetic line of force inertial wheel according to claim 7, wherein: the bottom cover and the face cover are tightly connected to the threaded cylinders and the sleeves through the screws, such that a tight connection is made between the bottom cover and the face cover.

12. The magnetic line of force inertial wheel according to claim 5, wherein the bottom cover is connected to the cut part by injection molding.

13. The magnetic line of force inertial wheel according to claim 5, wherein: the cut part is provided with a protrusion embedded in the isolate part in an inner side wall.

14. A method for manufacturing a magnetic line of force inertia wheel, used to manufacture the magnetic line of force inertia wheel according to claim 1, wherein the method being performed according to the following steps:
S1: preparing a bottom cover and a face cover by injection molding, when molding the bottom cover, a cut part made of a weak magnetic conductor being placed in a mold of molding the bottom cover in advance, such that the cut part is fixedly connected to the bottom cover;
S2: fixing a baffle ring with an outer diameter smaller than an inner diameter of the cut part on the bottom cover, and laying an isolate part made of at least one of a weak magnetic cementing material and a weak magnetic material between the baffle ring and the cut part;
S3: removing the baffle ring; and laying a counterweight part made of a mixture of the weak magnetic cementing material and the strong magnetic high-density material inside the isolate part;
S4: covering the face cover, such that the counterweight part, the isolate part and the cut part are fixed between the bottom cover and the face cover; and fixing the face cover and the bottom cover with fasteners.
